(19) United States
(12) Patent Application Publication
(10) Pub. No.: US 2016/0303598 A1
(43) Pub. Date: Oct. 20, 2016

(54) SANITARY LIQUID DISPENSERS

(71) Applicant: Martin Rifkin, Vancouver, WA (US)

(72) Inventor: Martin Rifkin, Vancouver, WA (US)

(21) Appl. No.: 14/688,966

(22) Filed: Apr. 16, 2015

(51) Int. Cl. B05B 9/04; B05B 9/00; B05B 12/12; A47K 10/38

(52) U.S. Cl. CPC B05B 9/0426; A47K 10/38; B05B 9/002; B05B 12/124; A47K 2010/328

(57) ABSTRACT

The present disclosure is directed to a liquids dispenser for delivering a mist or liquid. The liquids dispenser includes a liquids cartridge for holding a liquid and a cartridge receptacle coupled to the liquids dispenser. The dispenser further includes a pump and a heating element. The cartridge receptacle including electrical circuitry designed to detect a first condition such that when the first condition is met, the pump is activated and cartridge receptacle dispenses an aliquot of liquid or mist through a dispensing element. The heating element heats the liquid that travels through to the dispensing element and is dispensed when a second condition occurs. A motion sensor is also disposed on the cartridge receptacle for detecting the first condition. Finally, the dispenser includes a holder for either hanging or attaching the dispenser to a stable surface or object.

### BACKGROUND

The present disclosure relates generally to device for dispensing a spray of liquid, such as a disinfectant, cleaning solution, or a non-irritating skin sanitizing solution, for personal cleansing as well as for cleaning the toilet seat area before and after use. The sanitary liquid dispensers provides an environmentally friendly way of obtaining a higher level of personal hygiene.

For personal hygiene and comfort, it is often desirable to use sanitary moistened wipes or toilet paper after using the lavatory facilities. Moistened wipes are especially useful for those with medical conditions, such as hemorrhoids, where the use of dry toilet paper would be extremely uncomfortable and irritating to the affected areas. Further, parents with toddlers or children just starting to learn how to use the lavatory by themselves would benefit from a system where they can more effectively clean themselves after using the toilet. The elderly would be another population that would benefit from a faster, easier way of cleaning themselves after using the bathroom.

Currently, there are products on the market that allow such cleansing after bathroom use. Unfortunately, many of these products are not flushable or biodegradable, such as baby wipes. And even when these products are marketed as being flushable or biodegradable, they do not break down as quickly or as easily as toilet paper and have a greater chance of clogging city sewer systems and septic tanks, thus creating more waste. In addition, continuously having to replenish these types of wipes is also costly compared to a system where a sprayer can moisten regular toilet paper with water or the cleansing solution of a user's choice. Thus there exists a need in the current market for a dispenser that can be either hung on the toilet paper rack or mounted near the toilet and that provides touchless moistening of toilet paper.

A number of prior art patents disclose systems which are to be used in conjunction with toilet paper but none have the advantages of this current dispenser device. The following patents are representative and are incorporated herein by reference for all purposes: U.S. Pat. No. 5,887,759 to Ayigbe, U.S. Pat. No. 7,162,754 to Haile, Jr., and U.S. Pat. No. 5,443,084 to Saleur.

The liquid dispenser in Ayigbe is a dispenser and toilet paper holder combination. The Ayigbe combination dispenser has the disadvantage that it must be located with the toilet paper. A user has no choice of where to place the dispenser for either mechanical or aesthetic considerations. Further, because the spray is located right above the toilet paper roll, spraying single sheets of toilet paper may cause the toilet paper to disintegrate and come apart even before it is torn from the roll, and even more so when handled before use. Thus, a user would more likely tear the toilet paper off before pushing the button for dispensing the liquid, which defeats the benefit of having the dispenser opening right above the toilet paper roll. The Ayigbe dispenser also is a manual dispenser, which is less sanitary than a touchless one.

The device for moistening paper disclosed in Haile, Jr. uses primarily water. The water supply for this dispenser system taps into the existing water supply line. A user here would activate a lever to dispense an amount of water onto toilet paper. While this system is environmentally friendly, it requires the added hassle of installing a new outlet and water supply line for moistening the toilet paper. Further, the device of Haile, Jr. only reasonably allows for use of water and not other cleansing solutions of a user's choice. The Haile, Jr. dispenser here also is a manual operated dispenser, not a touchless one, which, as mentioned above, is less sanitary especially if placed in a location for public use.

Finally, the dispenser detailed in Saleur is integrated system for moistening toilet paper using a humidifying device that moistens the toilet paper and that is integrated with an electric toilet paper dispenser. When the roll is dispensed in Saleur, the toilet paper is “moistened” by humidifying means and a cutting member then cuts the toilet paper. While the Saleur system is advantageous for always providing a constant level of moistening, it is not a good device for users that want different levels of moisture on the toilet paper at different times. A user wanting a different level of moisture with the Saleur dispenser would somehow have to adjust the dispenser to suit his preferences, which would be inconvenient if persons in the same household had different preferences on the level of moistening.

Thus, there is need in this area for a solution dispenser that allows a user to decide what liquid to use for moistening toilet paper and the level of moistening to be provided. Further, a dispenser that can either be hung from existing toilet paper dispensers or mounted would allow user more options for locating a desired placement of the dispenser. There is also a need for a touchless dispenser to lessen the transmission of germs from one user to the next.

### SUMMARY

The present disclosure is directed to a liquids dispenser for delivering a mist of liquid. The liquids dispenser includes a liquids cartridge for holding a liquid and a cartridge receptacle coupled to the liquids dispenser. The dispenser further includes a pump and a heating element. The cartridge receptacle including electrical circuitry designed to detect a first condition such that when the first condition is met, the pump is activated and cartridge receptacle dispenses an aliquot of liquid or mist through a dispensing element. The heating element heats the liquid that travels through to the dispensing element and is dispensed when a second condition occurs. A motion sensor is also disposed on the cartridge receptacle for detecting the first condition. Finally, the dispenser includes a holder for either hanging or attaching the dispenser to a stable surface or object.

### BRIEF DESCRIPTION OF THE DRAWINGS

FIG. 1 is a drawing of a front view of a liquids dispenser.

FIG. 2 is a drawing of a side view of the liquids dispenser.

FIG. 3 is a drawing of a back view of the liquids dispenser.

FIG. 4 is a drawing of a bottom view of the liquids dispenser.

FIG. 5 is a drawing of the liquids dispenser in a first holder configuration.

FIG. 6 is a drawing of the liquids dispenser in a second holder configuration.

FIG. 7 is a drawing of the liquids dispenser in a third holder configuration.

FIG. 8 is a drawing of the liquids dispenser in a fourth holder configuration.

FIG. 9 is a drawing of the liquids dispenser in a first use.

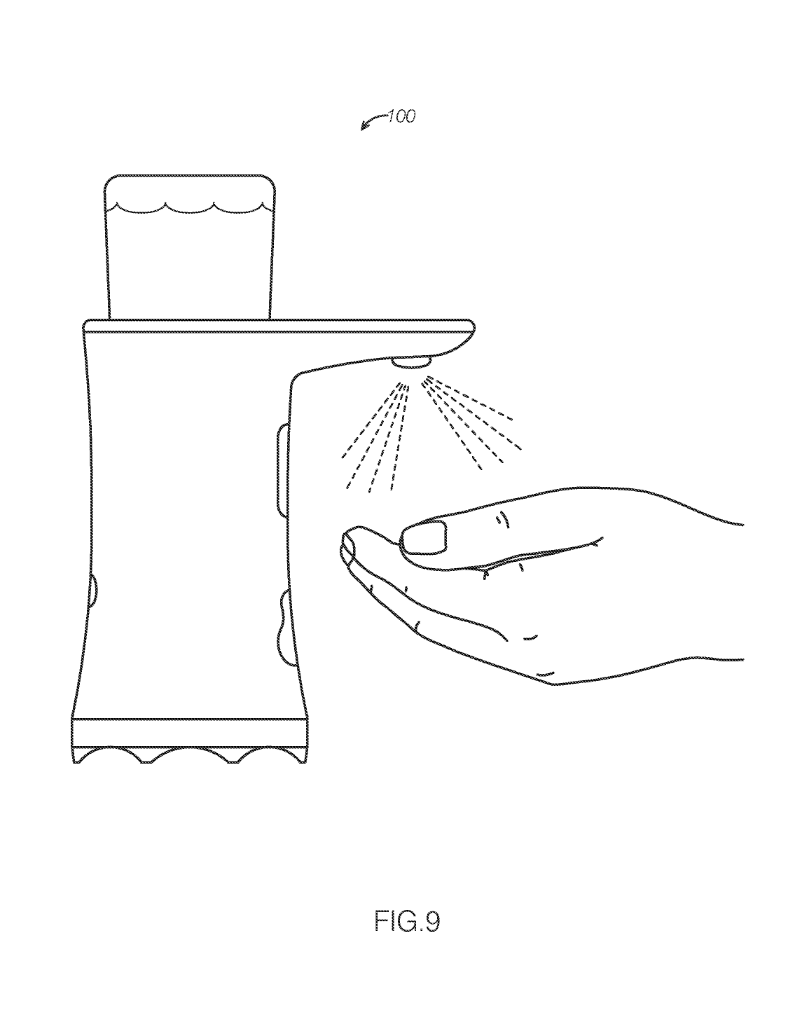

FIG. 10 is a drawing of the liquids dispenser shown for an alternative use.

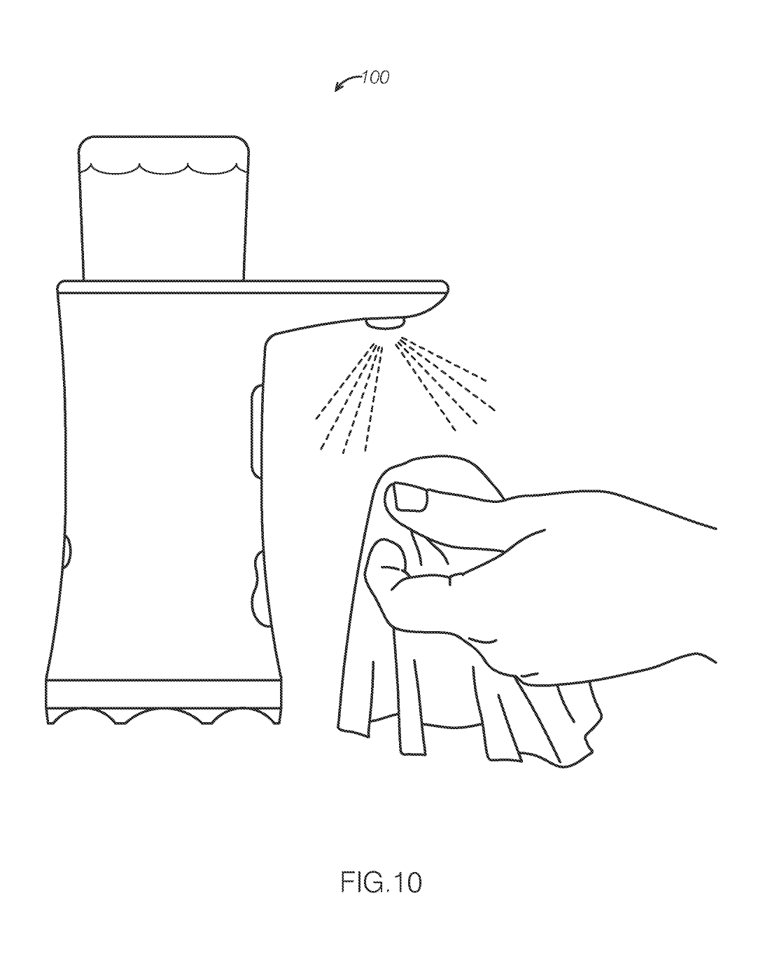

FIG. 11A is a drawing of a front view of a second embodiment of the liquids dispenser.

FIG. 11B is a drawing of a side view of the second embodiment of the liquids dispenser.

FIG. 11C is a drawing of a top view of the second embodiment of the liquids dispenser.

FIG. 11D is a drawing of a bottom view of the second embodiment of the liquids dispenser.

### DETAILED DESCRIPTION

The disclosed sanitary liquid dispensers device will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, a variety of sanitary liquid dispensers examples are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

Sanitary liquid dispenser disclosed in this application contains replaceable or refillable cartridges for replenishing the desired solution as well as the option of an adjustable strap or wall mounting and a sensor for touchless dispensing of the cleansing solution. Sanitary liquid dispenser provides an easy way to improve upon personal hygiene. Sanitary liquid dispenser has the benefit that the user can fill the cartridge with the cleanser of her choice. Further, sanitary liquids dispenser requires no special plumbing and may be hung or amounted anywhere that is convenient or aesthetically pleasing to the user.

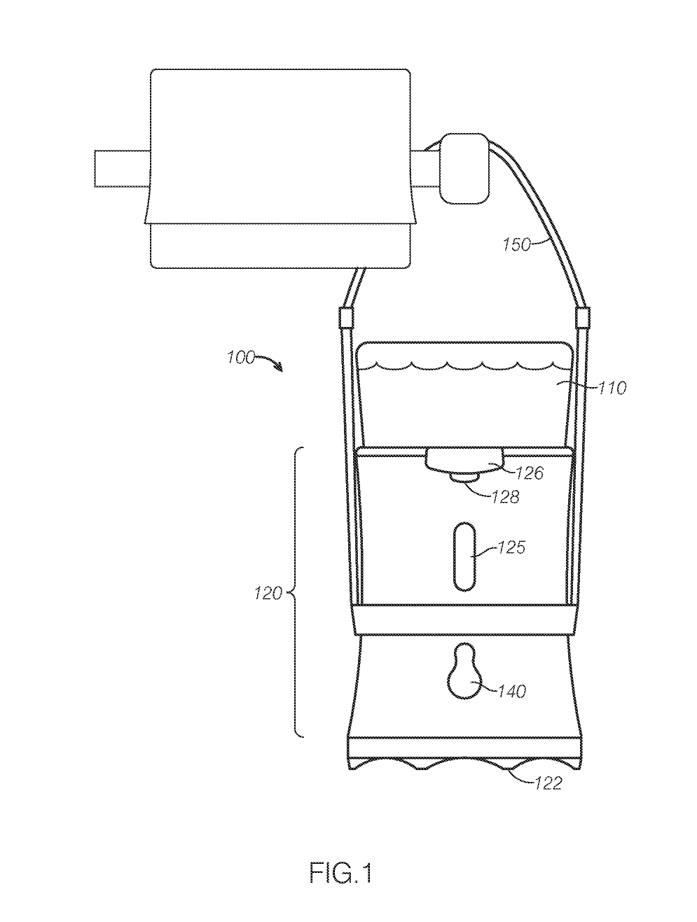

With reference to FIG. 1, a sanitary liquid dispenser 100 will be described with reference to a typical bathroom space. FIG. 1 shows one convenient location for the toilet roll dispenser, where it is hung on the toilet roll dispenser. Having the sanitary liquid dispenser 100 in this location allows a user to use sanitary liquids dispenser 100 before and after using the toilet. No special tools or nearby outlet are required. While sanitary liquid dispenser 100 may be readily used for personal cleansing, one may also use sanitary liquid dispenser 100 in other areas of the home or in a commercial setting.

Additionally or alternatively to attaching sanitary liquid dispenser 100 to an object, such as the toilet roll dispenser, with an adjustable strap 150, any feasible way of mounting touchless toilet paper spritzer 100 into place can be used. Suitable mounting techniques include mounting with screws, nails, adhesives onto a surface such as a wall, or can be any combination thereof. Other methods of mounting may include an eye and hook type attachment or a hook and pile attachment where either hook or pile portion is placed on sanitary liquid dispenser 100 and the corresponding member is attached to the surface of interest. Sanitary liquid dispenser 100 may also be hung from any item that is convenient for the user.

While sanitary liquid dispenser 100 may be readily used with toilet paper, one skilled in the art will appreciate that sanitary liquid dispenser 100 may be used in other settings where it would be desirable to have access to a cleaning or cleansing solution without the need for manual touch. Other suitable places where the sanitary liquid dispenser 100 may be used could include other areas of the house where cleanliness is important, such as the kitchen area. Outside the home, sanitary liquid dispenser 100 may be used in a commercial setting for cleaning and cleansing purposes, such as the entrance of a store where often there are sanitary wipes for wiping off a shopping receptacle. Sanitary liquid dispenser 100 has the advantage of providing wipes with fresh cleaning or cleansing solution on demand instead of providing wipes where the cleansing solution has already evaporated or even dried completely. Using sanitary liquid dispenser 100 has the further advantage of being compatible with an eco-friendly cleaning solution, which allows the used paper towels to be composted instead of placed in the garbage.

Further, no special plumbing is required for sanitary liquid dispenser 100 to work. In some of the prior art solutions, the corresponding devices require introducing an additional line, either from the sink or toilet water supply, to supply liquid to the dispenser. Sanitary liquid dispenser 100 needs no such adaptation. A user can easily fill the reservoir with water, a commercially purchased cleaning or cleansing solution, or a solution formed from the user blending ingredients she has on hand.

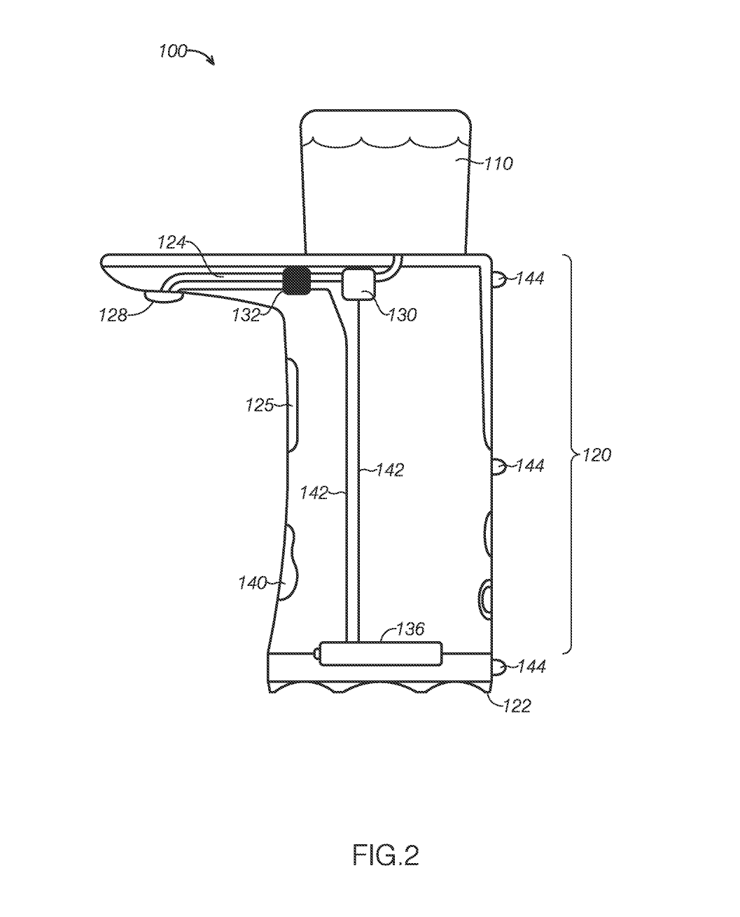

Turning to FIG. 2, sanitary liquid dispenser 100 is shown from the side and from a front angle. Sanitary liquid dispenser 100 includes a refillable liquids cartridge 110 and a cartridge receptacle 120. Cartridge receptacle 120 further includes a battery receptacle 136 that serves as the power supply, a dispenser 128, a length of tubing 124 that connects liquids cartridge 110 to dispenser 128, a touchless sensor 140, and an adjustable strap 150. Finally, cartridge receptacle 120 houses electrical circuitry that supplies power to a pump 132, a heating element 130, dispenser 128, and touchless sensor 140. Pump 132 draws fluid from the liquids cartridge in response to touchless sensor 140 detecting a first condition. In this embodiment, the first condition would be an object or motion detected within a preset distance from touchless sensor 140. Heating element 130 heat tubing 124 when electronic circuitry 142 senses a threshold amount of fluid in tubing 124. Heating element 130 heats the liquid dispensed for additional cleansing and sanitizing characteristics. In some examples, sanitary liquid dispenser 100 does not include a heating element. In other examples, sanitary liquid dispenser 100 includes a wall mounting feature that allows a user to affix sanitary liquid dispenser 100 to a vertical surface. Finally, other examples of sanitary liquid dispenser 100 may include a depressible button for dispensing the liquid instead of possessing a touchless sensor.

As FIG. 2 shows, liquids cartridge 110 is for retaining a solution of choice of the user. Liquids cartridge 110 includes a fill opening where a user may fill said cartridge with the solution of choice. In some embodiments, the fill opening is the same opening as the opening that mates with the opening located on the top portion of cartridge receptacle 120 to provide liquid to a dispenser 128. In other examples, the opening for filling liquids cartridge 110 is another opening found on the base end of liquids cartridge 110 with an independent closure or an opening at the top end of liquids cartridge 110 with a separate means for closing. Finally, liquids cartridge 110 contains impressions along the perimeter where it mates and couples the base of cartridge receptacle 120 for securing liquids cartridge 110 to cartridge receptacle 120. In other examples, sanitary liquid dispenser 100 may be one piece where the liquids reservoir is integrated and connected with the misting element. In the present embodiment liquids cartridge 110 is in plain sight, but in other embodiments, the liquids cartridge can be hidden from view and body of the cartridge receptacle conceals the liquids cartridge.

In the present embodiment, cartridge receptacle 120 receives liquids cartridge 110 and sits proximate to liquids cartridge 110 when the two are engaged. When cartridge receptacle 120 and liquids cartridge 110 are engaged with one another, there is fluid connection between liquids cartridge 110 and dispenser 128 through cartridge receptacle 120. Liquids cartridge 110 sits on top of cartridge receptacle 120. Washers that can be securely mated, are located between the opening at the base of liquids cartridge 110 and on the top of cartridge receptacle 120. The washers serve to prevent leakage of liquid from liquids cartridge 110 onto cartridge receptacle 120 when the two are engaged and sanitary liquid dispenser 100 is in use. Further, the openings that provide liquid from liquids cartridge 110 to cartridge receptacle 120 are aligned to allow fluid connection between the two components.

Cartridge receptacle 120 further includes at least one coupling point 114. Coupling points 114 are located at the top end perimeter of cartridge receptacle 120 and function to hold liquids cartridge 110 in place when liquids cartridge 110 is engaged with cartridge receptacle 120. As mentioned above, liquids cartridge 110 possess a corresponding impression or impressions along the perimeter of its outer wall that allows coupling points 114 to securely mate with the impression on liquids cartridge 110. In other examples, clips, mated grooves, male/female attachments and similarly mated parts may be used to secure liquids cartridge 110 to cartridge receptacle and base 120.

Cartridge receptacle 120 also includes a release 115. When release 115 is pressed, coupling points 114 become disengaged from their corresponding depressions on liquids cartridge 110 and thus release liquids cartridge 110 from cartridge receptacle 120. In other examples, the opening on the bottom end of liquids cartridge that provides cleansing solution to the dispenser is engaged with the opening at the top end of the cartridge receptacle, through threading components that allow one end to be screwed securely into a second end. In this latter example, no coupling points or release is required. One consideration for this latter example is that because there are no other points for the securing liquids cartridge into the cartridge receptacle, the cylinder wall into which the liquids cartridge sits may need to be taller to provide stability to the overall device when the liquids cartridge and the cartridge receptacle are connected.

Cartridge receptacle 120 further supports a piece of tubing 124 that connects the opening of liquids cartridge 110 with dispenser 128. When dispenser 128 is activated, dispenser 128 draws liquid from liquids cartridge 110 through tubing 124 and sprays liquid through dispenser 128 onto a surface chosen by the user. Dispenser 128 can be an atomizer, a spritzer, a mister, or a dispenser that delivers a measured aliquot of liquid. Tubing 124 may be made of plastic, metal or other synthetic pipe or tubing material. A person skilled in the art can decide whether a stiffer tubing made from metal or a more flexible tubing would be desirable for the connection between liquids cartridge 110 and dispenser 128.

As FIG. 2 shows, cartridge receptacle 120 further includes a protruding arm 126 proximate a top end of cartridge receptacle 120 and that projects from the side of cartridge receptacle 120. Protruding arm 126 houses tubing 124 where tubing 124 connects to dispenser 128. Dispenser 128 is further housed at the end portion of protruding arm 126 of cartridge receptacle 120. While the figures show protruding arm 126 as being oblong, the protruding arm may be any suitable shape as long as the protruding arm is suitable for housing the mister and the tubing that connects the mister to the liquids cartridge.

Further disposed on tubing 124 is heating element 130. Heating element 130, disposed on the portion of tubing 124 in close proximity to dispenser 128, supplies heat to tubing 124 when a second condition is met. In this embodiment, the second condition is when liquid starts to pass through tubing 124 on route to dispenser 128. By heating the cleansing liquid with heating element 130 as it passes through tubing 124, the liquid that reaches dispenser 128 will be more easily atomized and sprayed onto a desired surface, such as toilet paper. An added benefit for heating the cleansing or sanitizing liquid, is that warmer-than-room temperature liquid may be applied to the body region of a user, which provides more soothing cleansing than a cold, moistened toilette.

An auto sensor 140 and a viewing window 125 are also located on the body of cartridge receptacle 120. Auto sensor 140 senses when an object is within its vicinity and triggers dispenser 128 to pull liquid from liquids cartridge 110 and spray atomized liquid onto the object in its spray path. Touch-less sensor 141) also triggers heating element to provide heat to tubing 124. Touch-less sensor 140 is positioned where user can easily hold toilet paper or other wiping material and coordinate with dispensing element 128 to accurately spray atomized liquid onto the toilet paper or other wiping material. In some embodiments, the sensor is located on the front side of the cartridge receptacle and in other embodiments, the sensor is located adjacent or in the near vicinity of dispensing element 128. Viewing window 125 allows a user to see when liquids cartridge 110 is almost empty and requires replacement or refilling.

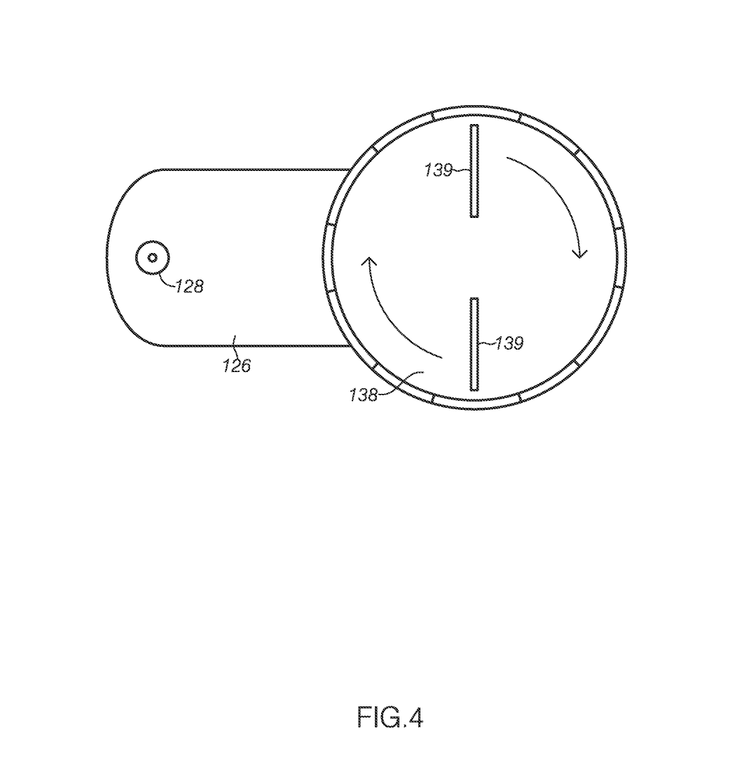

Cartridge receptacle 120 also includes a base end 122 as shown in FIG. 4. Contained within base end 122 is the power source for providing electrical power to heating element 130, dispenser 128, and auto sensor 144). The power source, such as batteries, are housed and electrically connected to heating element 130, dispenser 128, and auto sensor 140. The electrical connection are through standard means for connecting a battery supply to any number of electrical elements within a device. Furthermore, base can include a scalloped border that elevates the body and base of cartridge receptacle 120, such that when dispenser 100 is used in a non-hanging/directly-on-a-surface position and where there is likelihood that dispenser 100 might be used in an area where there is excess water (e.g. a sink area), electronic circuitry 142 adjacent to the base protected from moisture. Optionally, dispenser 100 also includes an ON/OFF switch. In other embodiments, the power supply may be a power cord which connects the sanitary liquid dispenser to an external power supply such as a wall socket. In yet other embodiments, the power supply may be located in another suitable region on cartridge receptacle.

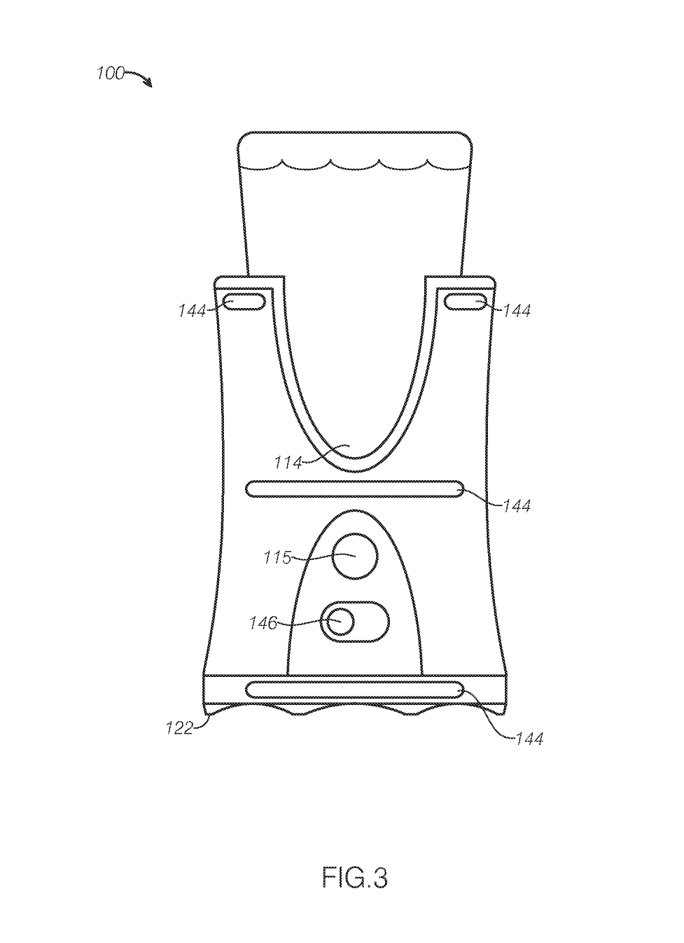

Cartridge receptacle 120 further includes bumpers 144 on its back surface. Bumpers 144 are disposed on various positions on the back side of cartridge receptacle 120 as shown in FIG. 3. Bumpers 144 prevents dispenser 100 from damaging the surface that it is situated against in certain hanging positions or when attached to a stable surface. Bumpers 144 may be made of rubber or plastic or any related materials that can prevent scratching or scuffing the surface that may come into contact with dispenser 100.

Further, base end 122 includes a bottom cover 138 that protects the power supply from debris and dust. Bottom cover 138 is slightly recessed from the bottom edges of base end 122. As FIG. 4 shows, bottom cover 138 threads into place on the bottom of cartridge receptacle 120 and securely screws into place. Bottom cover includes at least one protrusion 139. Protrusion 139 allows user to grip and turn bottom cover 138 and easily open bottom cover 138 to replace the batteries contained within. Alternatively, the bottom cover can securely fit onto the base of the cartridge receptacle by snapping the bottom cover into place. Finally, dispenser 100 can include an ON/OFF switch 146 as shown in FIG. 3.

The elements of sanitary liquid dispenser 100 may be composed of any suitable materials that allow sanitary liquid dispenser 100 to properly function. The elements of sanitary liquid dispenser 100 may be made of a single material or a combination of suitable materials. Ideally, liquids cartridge 110 is transparent. This makes it easy for a user to know when he or she has to replenish the cleansing solution. It would also be possible to have liquids cartridge 110 made of mostly opaque material but further include a window where user can see if the cleansing liquid needs to be refilled. Liquids cartridge 110 and cartridge receptacle 120 may be made of singularly or any combination of plastic, metal, glass, any suitable manufactured or natural material.

As shown in FIG. 1, sanitary liquid dispenser 100 includes an adjustable strap 150. Adjustable strap 150 attaches to top end of liquids cartridge 110 at two points minimally. In other examples, adjustable strap 150 may be attached to other suitable areas of touchless toilet paper spritzer 100. Adjustable strap 150 allow user to easily place touchless toilet paper spritzer 100 on existing toilet roll dispensers or on a wall-mounted hook or any similar protrusion where the device will be used. Adjustable strap 150 may be any suitable material that is flexible, either man made or natural. Examples of potential materials are plastic, natural rope, nylon, or leather. In other embodiment of this device, sanitary liquid dispenser 100 may be itself mounted onto a wall surface and would not require adjustable strap 150. In those instances, adjustable strap 150 may be easily removed.

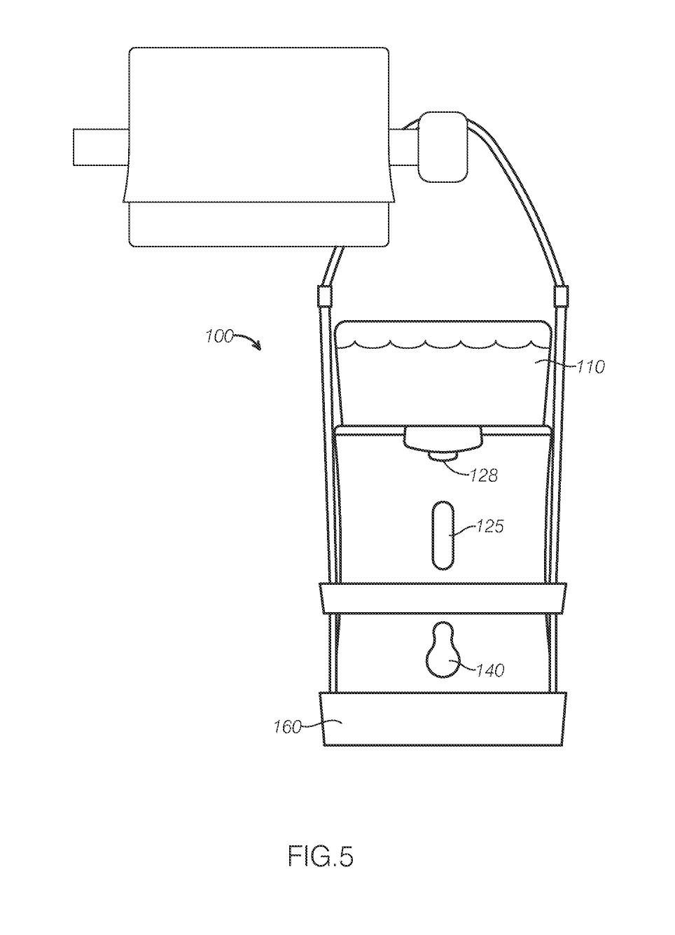

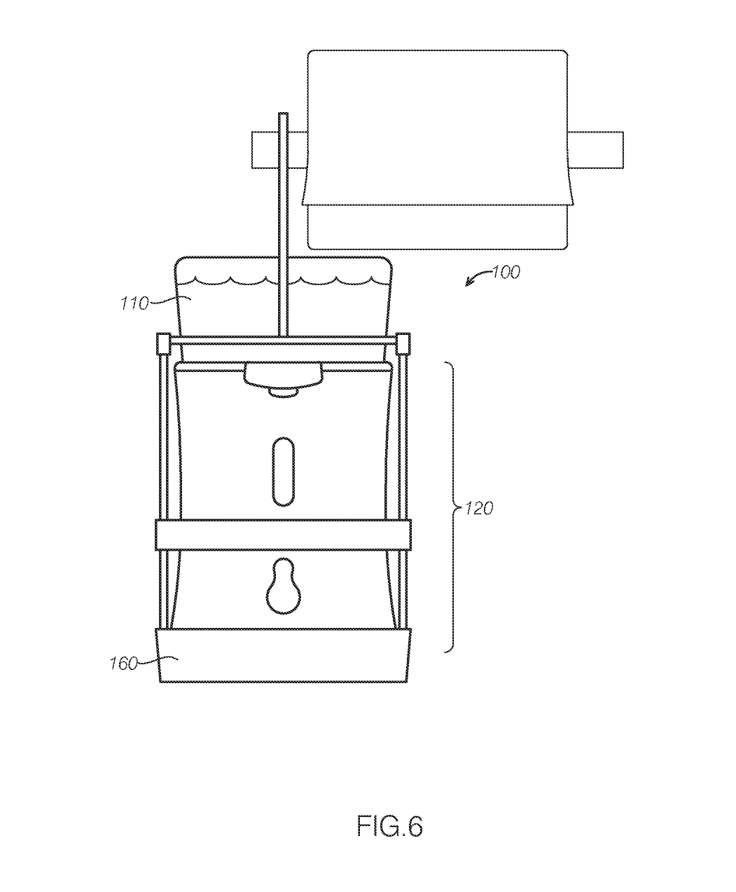

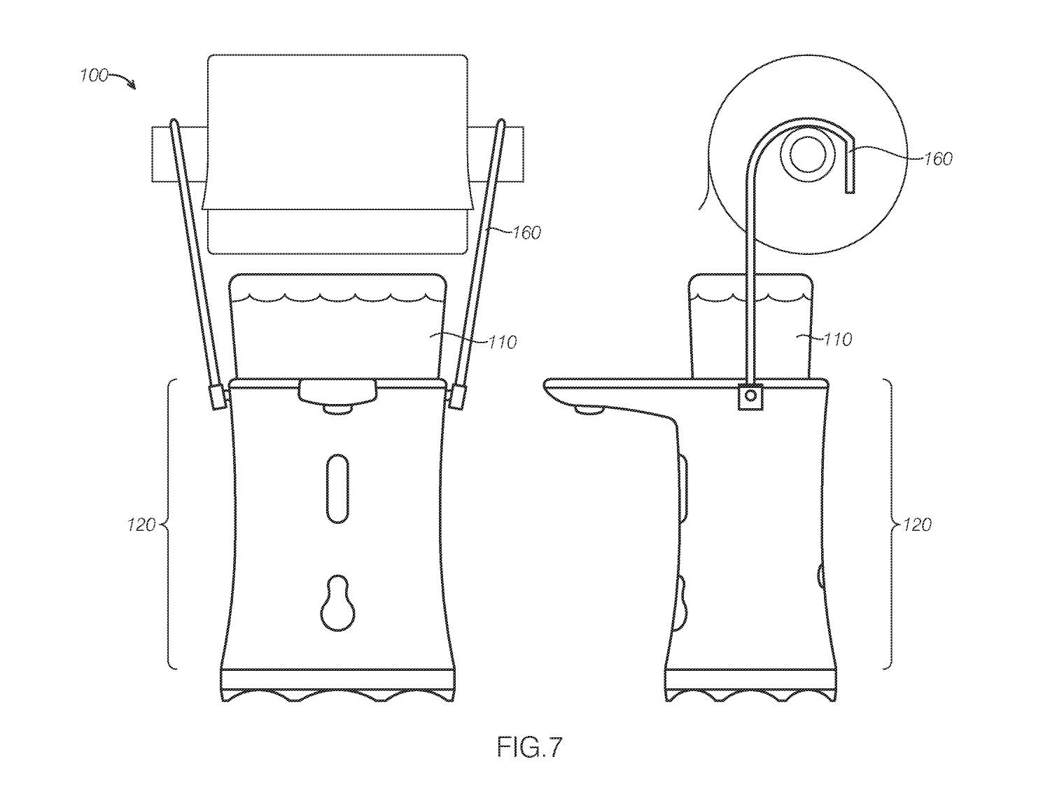

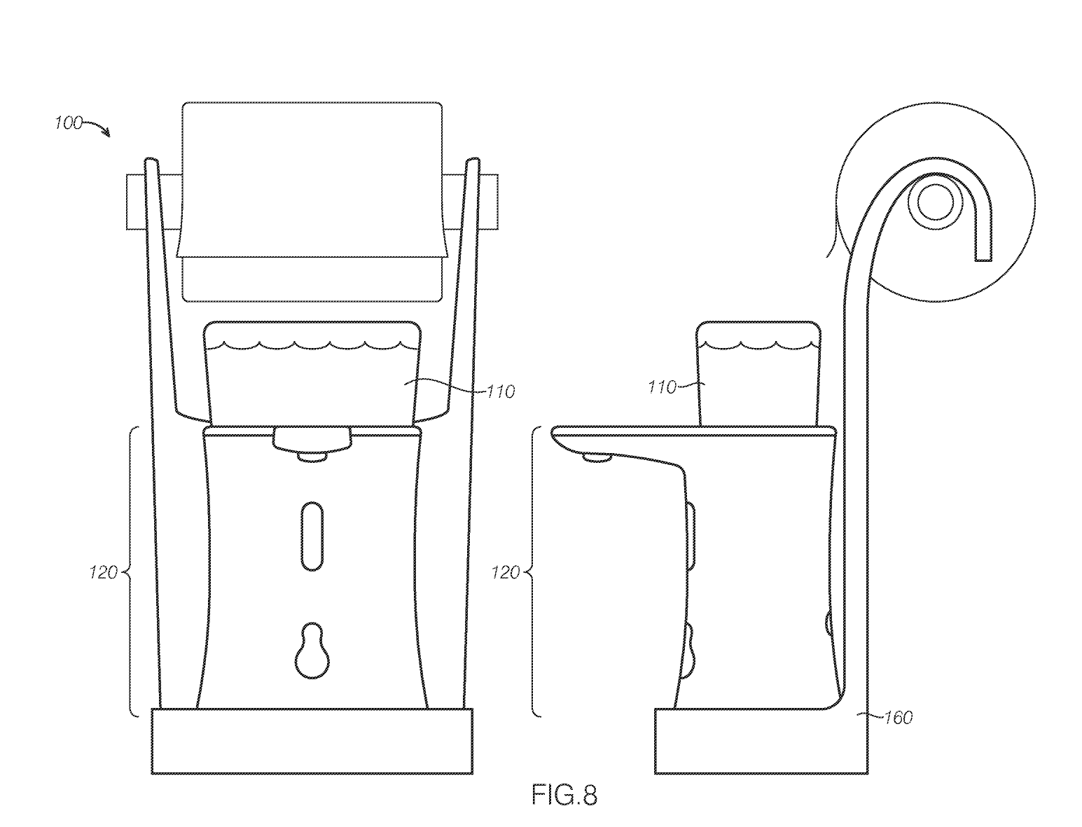

In other embodiments, sanitary liquid dispenser 100 can have a holder 160. FIGS. 5-8 shows various structures for holder 160. In FIGS. 5 and 6, holder 160 is has holster structure into which liquids dispenser 100 can fit. FIG. 7 shows holder 160 that attaches to the sides of cartridge receptacle 120 and having two hooking arms that attach to either end of a toilet paper dispenser, while FIG. 8 has the same hooking arms feature but instead, has an attached caddy on which liquids dispenser would sit.

A second embodiment of the sanitary liquids dispenser, dispenser 200, will now be described. Dispenser 200 share many similarities and identical features with the previously disclosed example. Thus, for the sake of brevity, each feature of dispenser 200, will not be described redundantly in great detail.

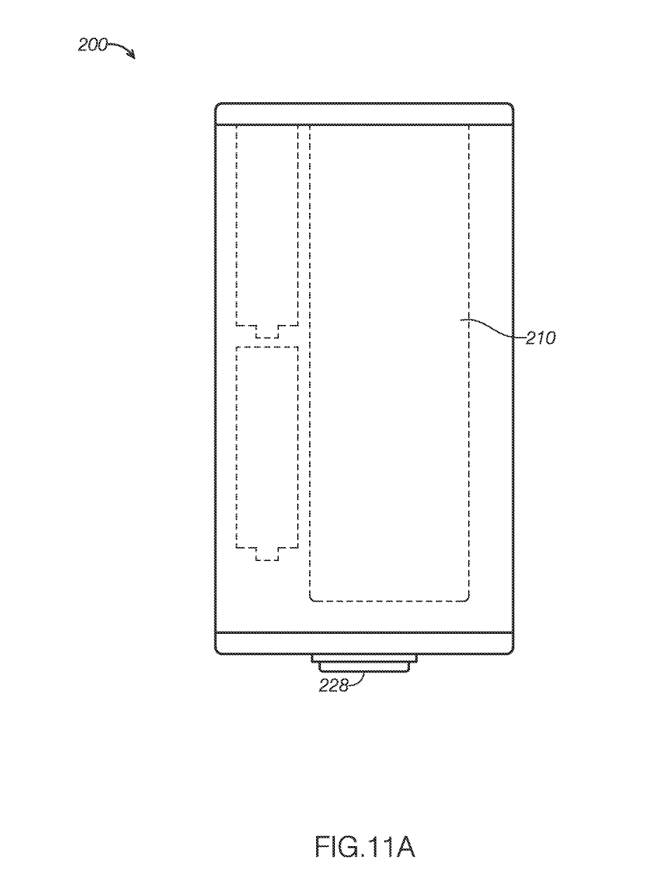

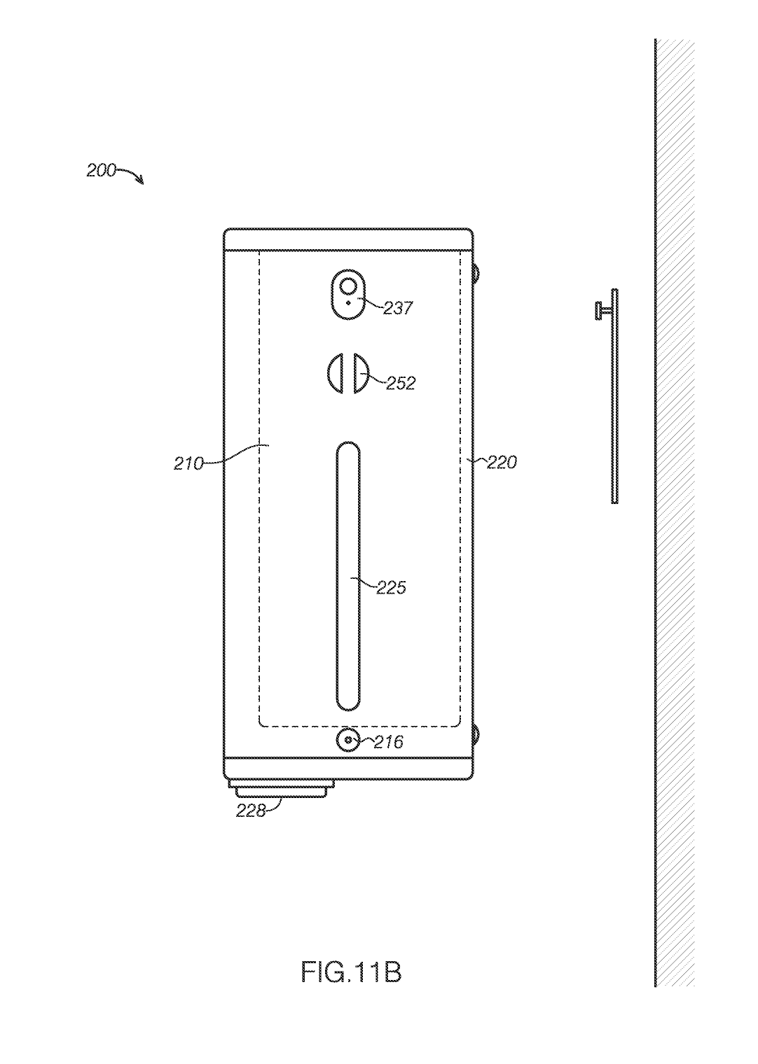

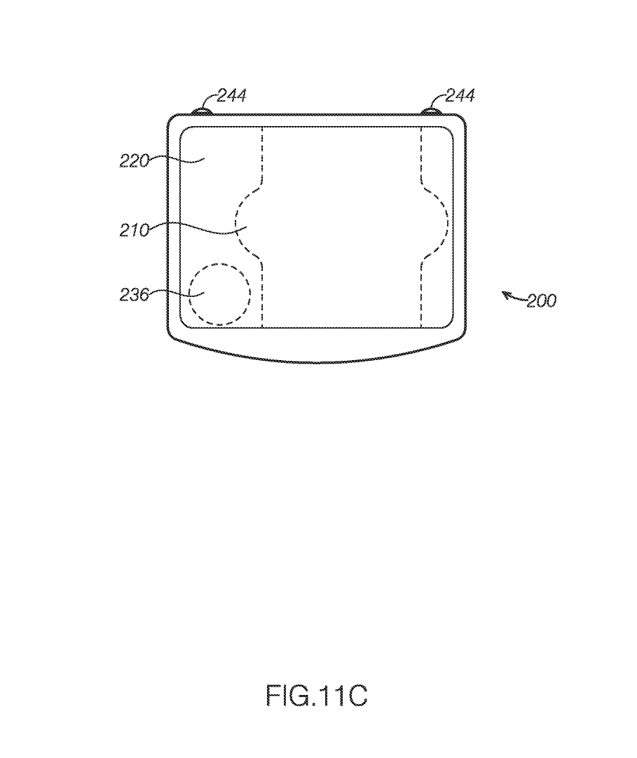

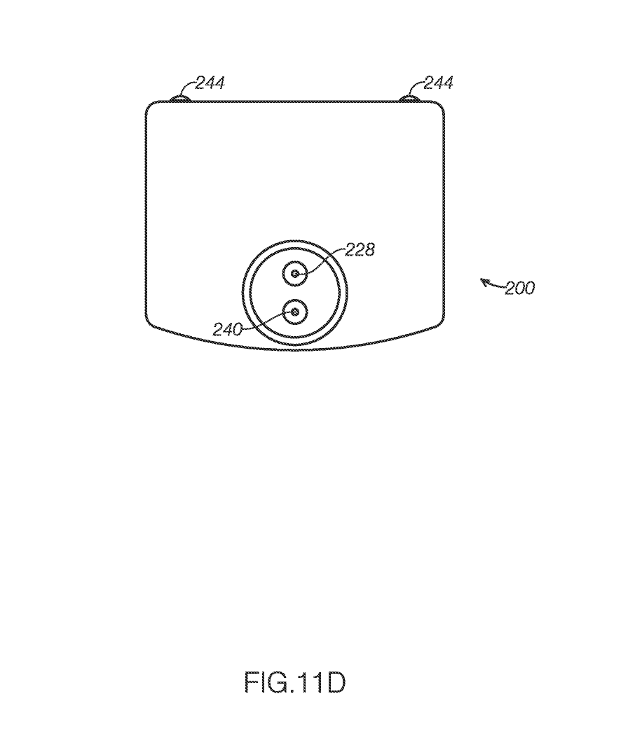

Dispenser 200 also contains a liquids cartridge 210 and a cartridge receptacle 220. The main difference between dispenser 100 and dispenser 200 is that liquids cartridge 210 is contained and mostly concealed within cartridge receptacle 220 as shown in FIGS. 11A and 11B. Also different from dispenser 100, cartridge receptacle 220 does not include a protruding arm. Instead, cartridge receptacle 220 is mainly rectangular in shape as shown and includes all the components described in dispenser 100. Another difference between dispenser 100 and dispenser 200 is that both the dispensing element 228 and the sensor 240 are located at the bottom end of cartridge receptacle 220. Parallel components include battery receptacle 236, a viewing window 225 to discern the level of the sanitizing liquid and when it is time to add addition liquid or change the cartridge, and a release 216 for releasing liquids cartridge 210. Because of its design, dispenser 200 works best when hung or mounted on a vertical surface or from an existing object. Thus, dispenser 200 also includes bumper to prevent marring the surface against which it is attached. Similar to strap system 150 of dispenser 100, dispenser 200 includes attachment points 252 on either side of cartridge receptacle 220. Dispenser 200 further optionally includes an ON/OFF switch 237 disposed on cartridge receptacle 220 as well as bumpers 244 disposed on the surface of cartridge receptacle 220 that abuts a surface.

In the two embodiments described, sanitary liquids dispenser 100 and 200 are largely cylindrical in shape. But in other embodiments, both the liquids cartridge and the cartridge receptacle may be any other suitable shape such as but not limited to square or rectangular or polygonal. In yet other embodiments, face plates or covers that fit over either the liquids cartridge, the cartridge receptacle, or both can be included to change to the look and style of the dispenser so that a user can match and coordinate the dispenser to the décor of a room. The face plates or covers can be attached with adhesives or magnetic strips or other appropriate adhering mechanism.

In other embodiments, the liquids dispenser may be stackable or fit side-by-side. This would be useful in a commercial setting when different sanitizing or cleansing solutions may be needed or used. In the stackable or side-by-side configuration, the multiple liquids dispensers may be attached to a sturdy surface or be placed in holders that can accommodate a multiple dispenser configuration, either in a stacked or side-by-side configuration.

In yet other embodiments, the liquids dispenser described above may also include a light. The light will be shown in a direction where a person using the liquids dispenser would hold the object onto which the liquid would be sprayed. The light would be placed in a location on the body of the cartridge receptacle such that when the auto sensor senses motion, it will simultaneously trigger the sprayer or mister along with the light turning on.

Finally, in other embodiments, the liquids dispenser can include a plate or pan disposed at the bottom of the liquids dispenser that catches drips from the liquids dispenser. The plate or pan can be part of the holder or an attachment onto the liquids dispenser or the holder.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A liquids dispenser for delivering a liquid or mist, comprising:
a liquids cartridge for holding a liquid;
a cartridge receptacle configured to selectively couple to the liquids dispenser and the cartridge receptacle further comprising an electric circuit adapted to determine a first condition and to dispense the liquid or mist from the liquids cartridge upon the first condition;
a dispensing element disposed in the cartridge receptacle, the dispensing element in fluid connection with the liquids cartridge, the dispensing element further comprising an electric pump operable in response to the first condition;
a heating element in electrical communication with the electrical circuit, the electrical circuit further adapted to determine a second condition, the heating element configured to operate at a first state in response to the second condition, the heating element further configured to heat the liquid or mist in the liquids cartridge in response to the second condition;
a motion sensor disposed on the front of the cartridge receptacle in electrical communication with the circuit, the motion sensor configured to detect the first condition; and
a holder for the liquids dispenser coupled to an exterior portion of the cartridge receptacle, whereby the holder for the liquids dispenser configures to attach to an existing surface.

2. The dispenser of claim 1, further comprising a length of tubing, the length of tubing comprising a tubing first end and a tubing second end, wherein;
the tubing first end is coupled to the liquids cartridge and the tubing second end is coupled to the dispensing element.

3. The dispenser of claim 1, wherein the dispenser further comprises:
a battery receptacle disposed in the cartridge receptacle, the battery receptacle in electrical communication with the electric circuit and configured for powering the electric circuit, the motion sensor, the heating element, and the dispensing element.

4. The dispenser of claim 1, wherein the heating element is disposed on or the length of tubing for heating the liquid that travels through the length of tubing to the dispensing element.

5. The dispenser of claim 1, wherein the dispensing element further comprising a pump disposed on the length of tubing and in electrical connection with the battery receptacle.

6. The dispenser of claim 1, wherein the cartridge receptacle further comprises at least one cartridge receptacle coupler on the cartridge receptacle and corresponding liquids cartridge coupler for maintaining the cartridge receptacle in fluid connection with the liquids cartridge.

7. The dispenser of claim 1, wherein the cartridge receptacle further comprises a viewing window on the front side of the cartridge receptacle, the viewing window is transparent for seeing when the liquids cartridge requires refilling or replacement.

8. The dispenser of claim 1, wherein the liquids cartridge comprises a transparent material from at least one or a combination of clear glass and clear plastic.

9. The dispenser of claim 1, wherein the dispensing element further comprises a nozzle configured to either spritz or mist the liquid when the first condition is met.

10. The dispenser of claim 1, wherein the first condition is a physical object is within a preset distance from and detected by the motion sensor.

11. The dispenser of claim 1, wherein the second condition is when the electrical circuitry detects fluid within the length of tubing.

12. The dispenser of claim 1, wherein the holder further comprising a strap for hanging the dispenser,
the strap connected from a first side of the cartridge receptacle to a second side of the cartridge receptacle.

13. The dispenser of claim 1, wherein the holder further comprises at least one hook.

14. The dispenser of claim 1, further comprising bumpers on the back side of the cartridge receptacle and the liquids cartridge to prevent marring any objects in contact with the dispenser.

15. The dispenser of claim 1, further comprising a catch plate adjacent to the bottom end of the dispenser for capturing excess liquid that drips from the dispensing element.

16. The dispenser of claim 1, further comprising a face plate or face cover with decorative designs that fits over the liquids cartridge or cartridge receptacle to change the overall look of the dispenser.

17. A method for providing heated liquids on an item such as toilet paper, the method comprising:
providing a liquids dispenser for delivering a liquid or mist, comprising
a liquids cartridge for holding a liquid;
a cartridge receptacle configured to selectively couple to the liquids dispenser and the cartridge receptacle further comprising an electric circuit adapted to determine a first condition and to dispense the liquid or mist from the liquids cartridge upon the first condition;
a dispensing element disposed in the cartridge receptacle, the dispensing element in fluid connection with the liquids cartridge, the dispensing element further comprising an electric pump operable in response to the first condition;
a heating element in electrical communication with the electrical circuit, the electrical circuit further adapted to determine a second condition, the heating element configured to operate at a first state in response to the second condition, the heating element further configured to heat the liquid or mist in the liquids cartridge in response to the second condition;
a motion sensor disposed on the front of the cartridge receptacle in electrical communication with the circuit, the motion sensor configured to detect the first condition; and
a holder for the liquids dispenser coupled to an exterior portion of the cartridge receptacle, whereby the holder for the liquids dispenser configures to attach to an existing surface liquids dispenser;
the method comprising:
hanging the liquids dispenser adjacent to a toilet paper roll dispenser;
providing a sanitizing liquid;
filling the liquids cartridge with the sanitizing liquid;
placing the liquids cartridge in the liquids dispenser;
detecting a first condition;
the pump drawing the sanitizing liquid through the length of tubing in response to the first condition;
the heating element warms the sanitizing liquid as it passes the segment of the length of tubing on which the heating element is disposed in response to the second condition; and
the dispensing element dispensing an aliquot of sanitizing liquid.

18. The method of claim 17, wherein the first condition comprises the motion sensor detecting a physical object within a preset distance from the motion sensor.

19. The method of claim 17, wherein the second condition comprises the electrical circuitry detects fluid as the fluid enters the length of tubing.

20. The method of claim 17, wherein the holder is a strap system attached to the cartridge receptacle for hanging or a stand for maintaining the liquids dispenser.
